(19) United States
(12) Patent Application Publication
(10) Pub. No.: US 2025/0232394 A1
(43) Pub. Date: Jul. 17, 2025

(54) METHOD OF PROVIDING GROUP MEMBER SERVICE TO MULTIPLE VEHICLES

(71) Applicants: HYUNDAI MOTOR COMPANY, Seoul (KR); KIA CORPORATION, Seoul (KR)

(72) Inventor: Seong-Soo Yae, Hwaseong-si (KR)

(73) Assignees: HYUNDAI MOTOR COMPANY, Seoul (KR); KIA CORPORATION, Seoul (KR)

(21) Appl. No.: 18/925,590

(22) Filed: Oct. 24, 2024

(30) Foreign Application Priority Data
Jan. 15, 2024 (KR) 10-2024-0005936

(51) Int. Cl. G06Q 50/43; G07C 5/00

(52) U.S. Cl. CPC G06Q 50/43; G07C 5/008

(57) ABSTRACT

Provided is a method of providing, to a group of vehicles to perform a specific task, a group service by assigning the group of vehicles corresponding roles in the group service based on vehicles' equipment options and capabilities and allowing the vehicles to carry out the corresponding roles. The method includes generating, by a plurality of vehicles, vehicle member information about vehicle members of a particular group in response to manipulation by drivers of the vehicles. The method further includes collecting, by a management server, the vehicle member information and determining and providing specific services by purpose to the group's vehicle members.

### CROSS-REFERENCE TO RELATED APPLICATION

This application claims priority to Korean Patent Application No. 10-2024-0005936, filed on Jan. 15, 2024 which is incorporated herein by reference in its entirety.

### BACKGROUND

### Field

The present disclosure relates to a group service technology for vehicles and, more particularly, to a method of providing a group service to a group of vehicles for performing a specific task.

### Description of Related Art

The technology of providing a group of vehicles with a specific service is still being developed. In general, what is called group autonomous driving is a field of research.

However, there is no related matters in the vehicle domain on how to create a group service in entertainment and relaxation modes (e.g., vehicle camping mode, party mode, etc.), and how to separately assign each vehicle in a group a corresponding role in the group service based on the vehicles' equipment options and provide the group service.

Although there is a mode called vehicle camping mode, it is not a group service, but an individual service that is only applicable to an individual vehicle.

However, as car champing is becoming more popular, there are many cases in which vehicles are traveling together and gathering to spend leisure time.

Therefore, outdoor services for vehicles called camping mode and party mode are being developed one by one, and customers are increasingly judging the services as criteria for purchasing vehicles.

The statements in this section merely provide background information related to the present disclosure and may not constitute prior art.

### SUMMARY

The present disclosure provides a method of providing a group service to a group of vehicles for performing a specific task by assigning corresponding roles to vehicles in the group based on vehicles' equipment options and capabilities and allowing the vehicles to carry out the corresponding roles.

Another objective of the present disclosure is to provide a method of providing, to a group of vehicles to perform a specific task, a group service by optimally establishing corresponding roles of the group of vehicles in the group service based on vehicles' equipment options (e.g., monitors, sound systems, etc.) and allowing the vehicles to carry out the corresponding roles.

An aspect of the present disclosure provides a method of providing, to a group of vehicles to perform a specific task, a group service by assigning the group of vehicles corresponding roles in the group service based on vehicles' equipment options and capabilities and allowing the vehicles to carry out the corresponding roles.

In one embodiment of the present disclosure, the method includes: generating, by a plurality of vehicles, vehicle member information about vehicle members of a particular group in response to manipulation by drivers of the vehicles; and collecting, by a management server, the vehicle member information and determining and providing specific services by purpose to the group's vehicle members.

In one embodiment, providing the vehicle member information may include: collecting, by an information collection part, the vehicle member information to generate a group member service database (DB); and determining, by a service setting part, available services based on the group member service database.

In another embodiment, providing the vehicle member information may include assigning, by a group setting part, a time-limited schedule to enable group services between the vehicle members of the group during the assigned time-limited schedule interval.

In another embodiment, generating the group member service database may include: determining whether the plurality of vehicles is within a specific communication distance; and updating the group member service database to a new group member service database for on-site vehicles within the specific communication distance according to the determination results.

The determination results may be obtained by using at least one of a location and an estimated arrival time of a shared vehicle among the plurality of vehicles.

In an embodiment, generating the vehicle member information may include: sending, by at least one client of the plurality of the vehicles, an acceptance response to a group participation request from the management server; and based on the acceptance response, performing a vehicle information sharing operation to allow the client to share the vehicle member information with a master of the plurality of vehicles.

The master may be either a group master of the particular group, or a service-specific master of the particular group determined for each of the group services.

The group master may be a vehicle of a particular group's organizer in the plurality of vehicles, and the at least one client may be the remaining vehicles among the plurality of vehicles.

In another embodiment, sharing the vehicle member information may include: checking, when specific services are selected by the group master, whether respective service-specific masters for the specific services are preset to be allowed; in response to determining that the service-specific masters are allowed, determining the respective service-specific masters; and in response to determining that the respective service-specific masters are not allowed, performing a group master management mode in which the group master randomly selects respective service-specific masters for specific services.

The authority of the respective service-specific masters may be transferable from respective vehicles acting as the service-specific master to vehicles acting as the client.

The authority of a destination route sharing service in which a destination is set in advance, a playlist sharing service in which a playlist currently playing in the master is shared, or a vehicle control service in which control is only allowed during vehicle stopping, which are not affected by vehicle equipment options, among the specific services, may not be transferred.

The authority of any one of a party mode-support service, a video mode-support service, and a music listening-support service, among the specific services, may be transferred to a vehicle having a highest score obtained by scoring the vehicles for the presence of specific components.

The vehicle member information may include chassis numbers, roles, modem numbers, wireless communication device information, end of life (EOL) information, video services, and streaming services of the vehicle members.

The management server may communicate with communication means provided in the plurality of vehicles or an application on a communication terminal provided by the plurality of vehicles' drivers.

According to the present disclosure, when arranging a group trip, group services may be configured by organizing the trip members and maximally utilizing the resources (specifications) of the vehicles among the organized trip members.

Further, another effect of the present disclosure is that group services are assigned to and provided by vehicles with resources suitable for providing the group services, thereby allowing for automatic division of roles among the group members.

Furthermore, a still another effect of the present disclosure is that as a result of the division of roles, the group-operating master (group master) or its owner may not be subject to a burden of providing the group services, thereby improving the quality of the group services.

### BRIEF DESCRIPTION OF THE DRAWINGS

FIG. 1 is a block diagram illustrating the configuration of a group member servicing system according to an embodiment of the present disclosure;

FIG. 2 is a block diagram illustrating a detailed configuration of a vehicle illustrated in FIG. 1;

FIG. 3 is a block diagram illustrating a detailed configuration of a management server illustrated in FIG. 1;

FIG. 4 is a flowchart illustrating a group member configuration process according to an embodiment of the present disclosure;

FIG. 5 is a flowchart illustrating a group service preparation process after the group member configuration process according to an embodiment of the present disclosure;

FIG. 6 is a flowchart illustrating a group service controlling process after the group service preparation process according to an embodiment of the present disclosure; and

FIG. 7 is an example of a group member service database according to an embodiment of the present disclosure.

The drawings described herein are for illustration purposes only and are not intended to limit the scope of the present disclosure in any way.

### DETAILED DESCRIPTION

The foregoing objectives, features and advantages are further described in detail with reference to the accompanying drawings, so that one of ordinary skill in the art to which the present disclosure belongs should readily practice the technical ideas of the present disclosure. In describing the present disclosure, when it is determined that a detailed description of the known art related to the present disclosure would unnecessarily obscure the gist of the disclosure, the detailed description is omitted.

Hereinafter, some embodiments of the present disclosure are described in detail with reference to the accompanying drawings. Like reference numerals are used to refer to identical or similar components throughout the drawings.

When a component, device, element, or the like of the present disclosure is described as having a purpose or performing an operation, function, or the like, the component, device, or element should be considered herein as being “configured to” meet that purpose or to perform that operation or function.

According to the present disclosure, since estimated grouping conditions and members often change from actual grouping conditions and members at an event site in configuring a group for group services, an on-site configuration method is added to update pre-configured groups to meet the current situations.

In this process, with a real-time feature adopted as an important element of the service configuration, vehicles that actually exist in the field are checked again during the service configuration to reflect respective roles of the vehicles in the group configuration and services.

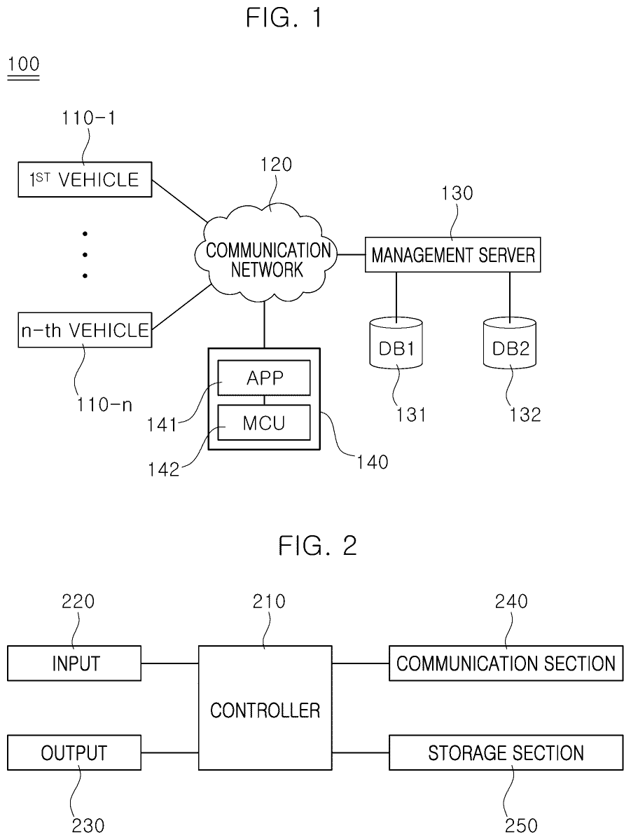

FIG. 1 is a block diagram illustrating the configuration of a group member servicing system 100 according to an embodiment of the present disclosure. Referring to FIG. 1, the group member servicing system 100 may include a plurality of vehicles 110-1 to 110-n, a communication network 120, a management server 130, and the like.

The first to n-th vehicles 110-1 to 110-n (n is a natural number of 2 or more) may be any vehicle capable of communicating with the communication network 120.

The communication network 120 performs a function of connecting a communication operation between the vehicles 110-1 to 110-n, as well as between the vehicles 110-1 to 110-n and the management server 130. For this purpose, the communication network 120 refers to a connection structure capable of performing information exchange between respective nodes, such as a plurality of terminals and servers, and may include a public switched telephone network (PSTN), a public switched data network (PSDN), integrated services digital networks (ISDN), broadband integrated services digital networks (BISDN), a local area network (LAN), a metropolitan area network (MAN), a wide area network (WLAN), and the like.

However, the present disclosure is not limited thereto, and may include wireless communication networks, such as code division multiple access (CDMA), wideband code division multiple access (WCDMA), wireless broadband (Wibro), wireless fidelity (WiFi), digital living network alliance (DLNA), Zigbee, Z-wave, high speed downlink packet access (HSDPA) networks, Bluetooth, radio frequency identification (RFID), infrared communication (infrared data association; IrDA), ultra-wide band, wireless universal serial bus (Wireless USB), near field communication (NFC) networks, satellite broadcast networks, analog broadcast networks, digital multimedia broadcasting (DMB) networks, and the like. Alternatively, the communication network may be a combination of these wired and wireless communication networks.

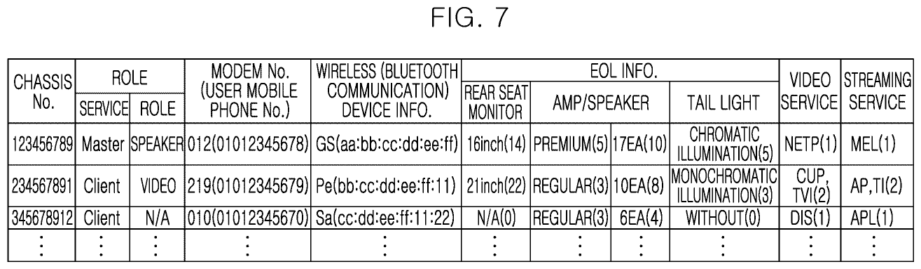

The management server 130 performs a function of organizing the vehicles (110-1 to 110-n) as group members and providing services to the group members. For this purpose, the management server 130 may include a first database 131 and a second database 132. The first database 131 may mainly include personal information of vehicle owners, vehicle information, and the like. The personal information may include phone number, address, gender, age, etc. The second database 132 may include information about the configuration of the group members. This is illustrated in FIG. 7.

The first database 131 and the second database 132 may be configured as a unitary database within the management server 130. Alternatively, they may be configured as a separate database server.

A communication terminal 140 may be utilized when a driver proceeds to directly configure group members without using the communication network of the vehicle. Additionally, if a request for a group member is sent to the communication terminal 140, it may be delivered as a text message or an app notification using an application 141, and the driver may respond to the request and become a member of the group. The communication terminal 140 may include a micro control unit (MCU) 142 that operates the application 141. In another form, the communication terminal may further include a communication circuit (not shown), a display (not shown), and the like.

In one form, the communication terminal 140 may be provided for each vehicle owner, or may be provided only for an owner of a vehicle used as a master.

FIG. 2 is a block diagram illustrating a detailed configuration of vehicles 110-1 to 110-n illustrated in FIG. 1. Referring to FIG. 2, the vehicles 110-1 to 110-n may include a controller 210, an input section 220, an output section 230, a communication section 250, a storage section 250, and the like.

The controllers 210 communicate signals and/or data to and from vehicle components to control the same. In particular, the controllers 210 perform a service such as trip scheduling, destination sharing, lighting control, multimedia control, music playlist sharing, etc., in response to the operation of a vehicle acting as a master among group members.

Here, the master role is assumed by the owner of the vehicle that organized the group, but it may be delegated and succeeded to another vehicle. Such a master is called a group master, and the succession may be performed on a service-by-service basis. Vehicles to be delegated with the master role for each service are designated as so-called service-specific masters, which reduces the burden on the group master. This also distributes the burden of the group services to improve service quality and reduces communication costs.

The input section 220 serves to receive driver's commands. Here, the commands may be provided via driver's manipulation, voice, touch, etc. Thus, the commands may be delivered via a manipulation key, a touch screen, a microphone, etc., and combinations thereof. The input section 220 may also serve as a display by using a touch screen.

The output section 230 serves to provide information to the driver. Thus, the output section may provide a setting menu screen, a guidance screen, a data processing screen, and the like. In another form, the setting menu screen, the guidance screen, the data processing screen, and the like may also be provided in combination with voice. For this purpose, the output section 230 includes a monitor, a sound system, and the like.

The monitor can be a liquid crystal display (LCD), a light emitting diode (LED) display, an organic LED (OLED) display, a touch screen, a flexible display, a head-up display (HUD), and the like.

The communication section 240 serves to send and receive data through a communication connection with the communication network 120. To this end, the communication section 240 may include a modem, a microprocessor, a microcomputer, a communication circuit, a memory, and the like.

The storage section 250 stores programs performing algorithms for performing services in response to the operation of a vehicle, acting as a master among group members, related data, and the like. For this purpose, the storage section 250 may be a memory provided within the controller 210, or a separate memory.

In one embodiment, the memory may include a combination of a non-volatile memory, such as a flash memory disk (solid state disk: SSD), a hard disk drive, a flash memory, an electrically erasable programmable read-only memory (EEPROM), a static RAM (SRAM), a ferro-electric RAM (FRAM), a phase-change RAM (PRAM), a magnetic RAM (MRAM), etc., and/or a volatile memory, such as a dynamic random access memory (DRAM), a synchronous dynamic random access memory (SDRAM), a double data rate-SDRAM (DDR-SDRAM), etc.

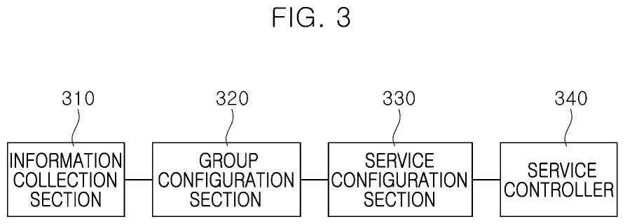

FIG. 3 is a block diagram illustrating a detailed configuration of a management server 130 illustrated in FIG. 1. Referring to FIG. 3, the management server 130 may include an information collection section 310, a group configuration section 320, a service configuration section 330, a service controller 340, and the like.

The information collection section 310 serves to collect vehicle member information from the first (110-1) to n-th (110-n) vehicles. The vehicle member information may include a chassis number, a role, a modem number, a wireless communication device information, end of life (EOL) information, a video service, a streaming service, and the like of a vehicle member. Of course, a group member service database may be organized based on this collected information.

An example of such a group member service database is illustrated in FIG. 7. Its details are described below. The group member service DB is related to information that is stored in a vehicle of an organizer who initially organized the group. The group member services DB is also created on the management server 130.

The group configuration section 320 sets a time-limited schedule and allows group services to be provided between group members only during that time period. Any member of the group may send a request for a group member via a unique modem number of the vehicle. The request for a group member may also be sent via the communication terminal 140. The group organizer's vehicle becomes the group master. When a person joins a group as a member, his/her vehicle is automatically shared in location with the group members.

The service configuration section 330 serves to determine the services that are available based on the group member service database. The available services include a party mode service, a video mode service, a music listening service, a destination route sharing service, a playlist sharing service, a vehicle control service, and the like. These services are briefly described as follows.
\textcircled{1} Party mode service: sound and lighting-related service (review factors: amplifier (speaker), tail light, streaming service)
\textcircled{2} Video mode service: the size of a rear seat monitor, whether the rear seat monitor is available shared, and a sound system are important (review factors: rear seat monitor, amplifier (speaker))
\textcircled{3} Music listening service: a sound system is important (review factor: sound system)
\textcircled{4} Destination route sharing service: the route entered by the master is sent to the group members so that all group members have the same route. Additionally, as soon as the master sends the route, the group members are also set with the vehicle route. If the group service is in an OFF state, the route is received but not automatically set.
\textcircled{5} Playlist sharing service: the master's music playlist is delivered to each vehicle in the form of a URL, and group members using the same music application in respective vehicles may share the playlist, which will play automatically.
\textcircled{6} Vehicle control service: lighting control, door (including tailgate) opening control, seat control, monitor control, etc. are performed by the group master.

The service controller 340 serves to control the services provided. For this purpose, the controller has a logic to control the services provided.

The information collection section 310, the group configuration section 320, the service configuration section 330, and the service controller 340 illustrated in FIG. 3 each refer to a unit that processes at least one function or operation, which may be implemented in software and/or hardware. The hardware may be implemented as an application specific integrated circuit (ASIC), digital signal processing (DSP), a programmable logic device (PLD), a field programmable gate array (FPGA), a processor, a microprocessor, other electronic unit, or a combination thereof designed to perform the functions described above.

Software implementations may include software components (elements), object-oriented software components, class components and task components, processes, functions, attributes, procedures, subroutines, segments of program code, drivers, firmware, microcode, data, databases, data structures, tables, arrays, and variables. The software, data, etc. may be stored in a memory and executed by a processor. The memory or processor may employ a variety of means well known to those skilled in the art.

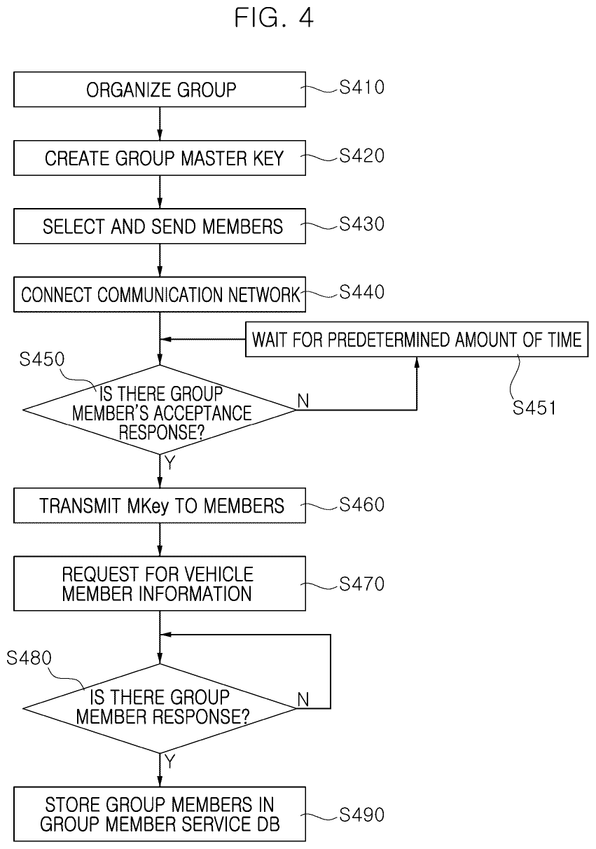

FIG. 4 is a flowchart illustrating a group member configuration process according to an embodiment of the present disclosure. Referring to FIG. 4, a driver of one of the first to n-th vehicles (110-1 to 110-n) requests the management server 130 to organize a group (an operation S410). In this case, a vehicle driver (i.e., the owner) who initially organized the group becomes the group master.

The driver requests the group organization via the vehicle's input section 220 and communication section 240, but the present disclosure is not limited thereto, and the driver may also request the management server 130 to organize a group via an application 141 installed on his/her communication terminal 140.

By default, the vehicle owner who organized a particular group has the authority of a group master. The master may provide services via the vehicle or the application installed on the communication terminal. In addition, the master has the authority to control the group services. However, it is possible to operate the master separately for each service, and if an automatic setting mode is selected, a vehicle having a configuration that meets the review factors of the services provided above automatically has the authority of a master for a corresponding service.

If a group master clicks Allow service-specific master, masters for respective services are set. However, in the case of destination route sharing service, playlist sharing service, and vehicle control service, which are not affected by the vehicle's equipment options, the authority of the group master is not transferred.

When a group is organized, a group master key is created, and when a group master selects vehicle members, the corresponding vehicles send group member information to the management server 130 (operations S420 and S430). In this case, a communication network is connected between the vehicles 110-1 to 110-n and the management server 130 (an operation S440). Communication is performed via an app message from an application on the communication terminal 140, a text message from the communication terminal 140, a communication section 240 as a vehicle communication means, and the like.

In addition, the group master creates a random key (hexadecimal, 16 bytes) called a “master key (Mkey)” and transmits the master key to the group members, and communication is performed between the group members through the key. The master key is a message decryption key, which may be interpreted as a control message to perform the control operation.

After connection of the communication network, the vehicle acting as a master (i.e., the master vehicle) checks whether there is an acceptance response from the remaining vehicles (i.e., the client vehicles) to the request for joining the group (S450). When the group members are organized, a group member organizer's vehicle sends a request for vehicle information to each group member vehicle.

In an operation S450, if the group member's acceptance is confirmed, the master vehicle sends a master key (Mkey) to the group members and requests for vehicle member information to the members (an operation S470).

In addition, a driver who organizes a group may press a group mode configuration menu displayed on a screen of the output section 230 of the vehicle, input members' mobile phone numbers or vehicles' modem numbers, and press Group Organization. In this case, a group link is sent to the remaining vehicles' drivers, and when the remaining vehicles' drivers press the link, guidance information about such as the group name/purpose/duration is sent and displayed on the screen. If the remaining vehicles' drivers select “Allow” in this information, they become group members.

The master vehicle then checks if there is a group member response (S480).

In an operation S480, as a result of checking, if there is a group member response, it is stored in the group member service DB (an operation S490). In other words, the vehicles that responded to the request to join the group are set to share vehicle information, and each vehicle shares end-of-life (EOL) information with the master vehicle.

In addition, the master vehicle checks the vehicle member information of the client vehicles, requests and collects the hardware options to and from the client vehicles (e.g., various controller information, infotainment system information), and requests and collects the application information being used to and from each vehicle. The collected information is created and managed as a group member service DB.

On the other hand, in an operation S480, as a result of checking, if there is no group member response, a process proceeds to the operation S480 again.

On the other hand, in the operation S450, if there is no acceptance response from the group members, the master vehicle waits for a certain period of time (an operation S451).

In other words, the master vehicle organizes a group, sends a request message to the participants, and waits for a response for a certain period of time. The process then proceeds to the operation S450.

The vehicle acting as the master may control the rest of the vehicles or receive data through communication between group members based on the group member service database. Of course, the group members may send and receive data to and from each other via communication terminals.

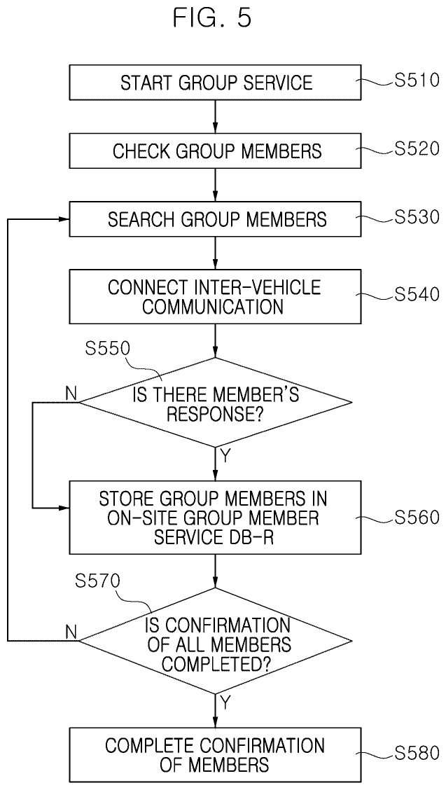

FIG. 5 is a flowchart illustrating a group service preparation process after the group member configuration process illustrated in FIG. 4 according to an embodiment of the present disclosure. Referring to FIG. 5, if the group member service database is completed, the master vehicle selects starting the group service (an operation S510).

The group service basically has pre-configured group members, but not all of them may arrive at the same place simultaneously. Therefore, the initially configured group member information becomes the service determination data, but it is necessary to newly configure the members on site at the time requesting for the actual service.

When the master vehicle selects starting a group service, a process of checking the group members is performed (an operation S520).

The master vehicle then performs a group member search to confirm the group members, and inter-vehicle communication is established (an operation S530). The tailgate of each vehicle is opened and the master vehicle starts searching for vehicles in the vicinity (short range). The “group member system database” is updated once again with the information of the vehicles within a communication distance. That is, the users who will actually use the service are selected.

In addition, the master vehicle checks the location and/or estimated time of arrival (ETA) of the shared group member vehicles that have not been searched in the short range, and if there is a vehicle arriving within about 5 minutes, the vehicle is confirmed as an available member and is updated in the “group member system database”.

The master vehicle then checks if there is a group member response from the client vehicles (an operation S550).

As a result of the operation S550, if there is the group member response from a vehicle, the management server 130 keeps the vehicle as a group member. When there is no response from a vehicle, the management server deletes the vehicle from the group members and stores the data in an “on-site group member service database (DB-R)” (an operation S560). The master vehicle will always update the “group member system database” by periodically searching for neighboring vehicles.

Thus, late arriving vehicles will have their vehicle information updated when they arrive at their destination. However, if the service is in progress, the vehicles will not be able to join the service. This real-time group member information created on-site becomes the “on-site group member service (DB_R)”.

Then, the master vehicle checks whether all vehicle members have arrived at the site (an operation S570).

As a result of the operation S570, if all of the vehicle members have arrived at the site, an on-site arrival process is terminated (an operation S580).

Alternatively, as a result of the operation S570, if all of the vehicle members have not arrived at the site, the operations S530 to S570 are performed again.

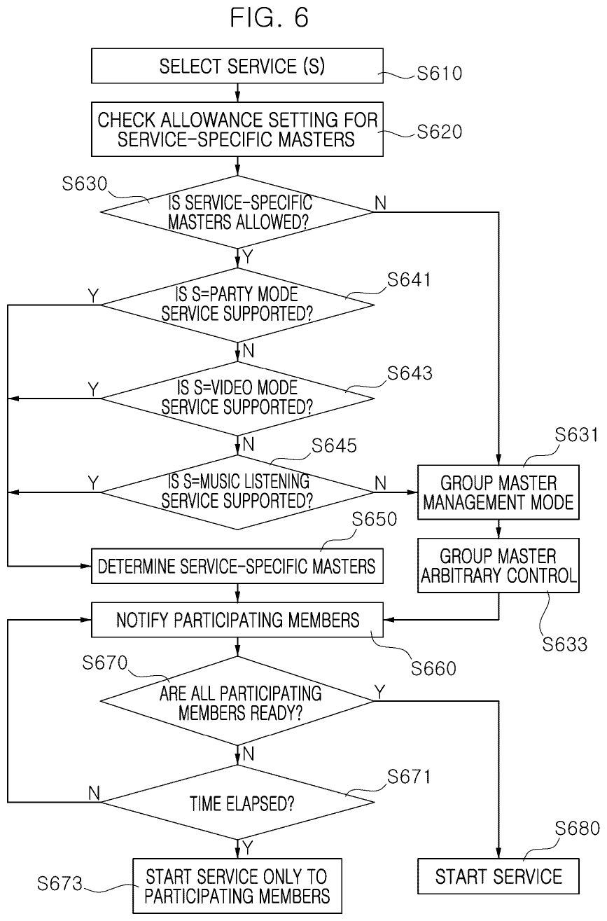

FIG. 6 is a flowchart illustrating a group service controlling process after the group service preparation process of FIG. 5 according to an embodiment of the present disclosure. Referring to FIG. 6, a driver of the master vehicle selects a service “S” to be provided to the group via the input section 220 (an operation S610). Further, the group master creates a random key (hexadecimal, 16 bytes) called a “master key” and transmits it to the group members so that communication between the group members is performed through the key.

Then, the management server 130 checks whether the service-specific master is allowed or not (operations S620 and S630). In addition, when a group master presses Allow service-specific masters in the group service setting item of the vehicle or the application 141 of the communication terminal 140, service-specific masters for the party mode service, video mode service, and music listening service are automatically set using the vehicle specifications in the “group member service database (DB)”.

The group master will transfer the “group member service database (DB)” to the service-specific masters. This may allow each group service-specific master to have the authority to control the service to connect the service to the necessary group members so that the group members may receive the necessary control and/or data. If Allow service-specific masters is not selected, the group master will manually select each service-specific master. In other words, the Allow service-specific masters is a default value.

As a result of checking in the operation S630, if the service-specific masters are allowed, the management server 130 checks whether the service supports a party mode service (an operation S641).

As a result of checking in the operation S641, if the service supports the party mode service, the management server 130 determines a master for the party mode service (an operation S650).

To explain the determination of the master for the party mode service, the determination is based on the addition of two factors: amplifier (speaker) and tail light. However, the streaming service needs to be available. If not, a vehicle with the highest score for a specific component is determined as a master for the party mode service.

For example, if a specific vehicle (e.g., GV80) includes amplifier/speaker and tail light (amplifier/speaker (15)+tail light (5)+steaming service (1)=21 points), the specific vehicle has the highest score, and thus becomes the master. The party mode service-specific master determines a vehicle with the highest amplifier/speaker score with reference to the group member service database (DB). The master authorization notification is displayed on the selected vehicle or the application 141 on the communication terminal of the selected vehicle's owner, and controllable services (music selection, lighting control) are displayed. The owner may select music and control light at his/her will.

If a vehicle includes amplifier/speaker, the vehicle usually becomes the master, because the amplifier/speaker score is reflected in a large percentage. Light is also a factor in determining the master, but the maximum score of the light itself is 5, so the master is almost entirely determined by the performance of the amplifier/speaker. The determined master requests a connection with reference to the group member service database (DB) and is authorized to control the tail light of each vehicle member.

The lighting control is basically set by the vehicle or app, and lighting options such as psychedelic light mode, dimmed light, and bright light may be selected to control the lights of all vehicle members.

The controllable sound mode includes a mode of sound reproduction from my vehicle and a mode of sound reproduction from both my vehicle and client vehicle. Accordingly, if the mode of sound reproduction from both my vehicle and client vehicle is selected, the vehicle with the second better performance amplifier/speaker is automatically selected with reference to the group member service database (DB), so that the sound is reproduced from both vehicles.

Referring to FIG. 6, if the party mode service is not supported in the operation S641, the management server 130 checks whether the video mode service is supported (an operation S643).

In the operation S643, if the video mode service is supported, the management server 130 determines a video mode service-specific master (the operation S650).

To explain the determination of the video mode service-specific master, it is determined by adding scores of the rear seat monitor and the amplifier/speaker, which are determination factors. However, the video mode service needs to be available. If not, a vehicle with the higher score for the specific component is determined. For example, if a specific vehicle (e.g., Palisade) includes a rear seat monitor and amplifier/speaker (rear seat monitor (22)+amplifier/speaker (11)=33 points), the specific vehicle has the highest score, and thus becomes the master.

The master authorization notification is displayed on the selected vehicle or the application on the communication terminal 140 of the selected vehicle's owner, a controllable service (video control) is displayed on the selected vehicle or the application on the communication terminal 140 of the selected vehicle's owner, and the owner may select and control streaming contents at his/her will.

The selected master vehicle will refer to the group member service database and if there is a vehicle (e.g., GV80) with better performance amplifier/speaker than the master vehicle, the master vehicle will request a wireless connection to that vehicle and prepare to deliver sound.

Here, the master vehicle acts as a source and the selected client vehicle acts as sinker. When the selected client vehicle receives a play signal from the master vehicle, the client vehicle automatically switches to a wireless music playback mode (including a Bluetooth audio mode) and outputs the sound delivered from the master vehicle.

If the video and music are separated, it will cause synchronization problems. Bluetooth audio basically has a delay report function to control these delay issues. Therefore, it is advantageous to use Bluetooth to transmit music, so Bluetooth transmission is the default value.

The controllable sound modes include a mode of sound reproduction only from the client, and a mode of sound reproduction from both my vehicle and the client vehicle.

Referring to FIG. 6, as a result of checking in the operation S643, if the video mode service is not supported, the management server 130 checks whether the music listening service is supported (an operation S645).

In the operation S645, if the music listening service is supported, the management server 130 determines a music listening service-specific master (the operation S650).

To explain the determination of the video mode service-specific master, the determination uses the score of the amplifier/speaker as a determination factor. However, a streaming service needs to be available. If not, a vehicle with the higher score is determined. For example, a specific vehicle (e.g., GV80) with a highest score (15) for amplifier/speaker is determined as a master.

The master authorization notification is displayed on the selected vehicle or the application 141 on the communication terminal 140 of the selected vehicle's owner, a controllable service (video control) is displayed on the selected vehicle or the application on the communication terminal of the selected vehicle's owner, and the owner may select and control streaming contents at his/her will. The controllable sound mode includes a mode of sound reproduction from my vehicle and a mode of sound reproduction from both my vehicle and client vehicle.

If the mode of sound reproduction from both my vehicle and client vehicle is selected, the management server 130 automatically determines a vehicle (e.g., the Palisade) with the second better performance amplifier/speaker with reference to the group member service database, so that the sound is reproduced from both vehicles.

Referring to FIG. 6, as a result of checking in the operation S645, if the music listening service is not supported, the management server 130 executes a group master management mode and controls an arbitrary service (operations S631 and S633). The arbitrary service may be one of a destination route sharing service, a playlist sharing service, and a vehicle control service (i.e., a vehicle camping mode).

Then, the service-specific master or group master provides notification information to the group members participating via the management server 130, and the group members receiving the notification information send response messages (an operation S660).

Additionally, in the case of the destination route sharing service, when the group service is initiated, the route set by the group master is delivered to all members, and the members' vehicles or apps are inquired “Do you want to set the route received from the master?”, and each vehicle owner decides whether to set the route by selecting “Yes” or “No”. Since the destination is basically the same for all group members, this function serves to save group members' trouble of setting the same destination individually.

In the case of the playlist sharing service, if the group master selects the playlist sharing service while the group service is started, the playlist currently playing in the group master vehicle is delivered to each vehicle. The delivery may be done in the form of a uniform resource locator (URL). Since each vehicle has a different music streaming service, vehicles with the same music player as the group master may receive and play the playlist. Vehicles with different music streaming services may not be linked.

In the case of the vehicle control service in the vehicle camping mode, the group master vehicle may perform light control, door (including tailgate) open control, and seat control after the group service is started. When executing the above three domain controls displayed on the group master vehicle or app, the group master transmits control commands to the wireless device addresses of each vehicle with reference to the group member service database.

Messages may be sent in parallel so that vehicles are able to operate immediately and simultaneously. After receiving the control signal from the group master, the client vehicles receive the control message and operate simultaneously in response to the control of the master vehicle. However, all vehicle control services are allowed to be controlled only when the vehicle is stopped (P-stage) and are not controlled by the group master in other conditions.

The management server 130 checks whether the participating group members are all ready by completing responses to the joining inquiry (an operation S670).

As a result of checking in the operation S670, if the group members are all ready to join the group, the service is initiated (an operation S680).

In contrast, as a result of checking in the operation S670, if some group members are not ready to join the group, the service-specific master or group master checks whether a predetermined amount of time period has elapsed (an operation S671).

As a result of checking in the operation S671, if the time period has not elapsed, the operations S660 to S671 are carried out again.

In contrast, as a result of checking in the operation S671, if the predetermined amount of time period has elapsed, the service-specific master or group master initiates the service only to the participating group members (an operation S673).

In other words, in the case of the vehicles participating for services, the group master (or service-specific master, if any) sends a notification to the selected vehicle (owner) and the owner's app informing them of their roles in the services, and the vehicles that receive the message are placed by themselves in appropriate locations. In other words, respective group members place their vehicles according to their roles and send a placement-completion response.

Once the vehicles are placed, the service provider vehicle members send a ready message to the group master or service-specific master, and the group master or service-specific master presses Start Service (play contents) to start the selected group service.

FIG. 7 is an example of a group member service database according to an embodiment of the present disclosure. Referring to FIG. 7, the group member service database may include a chassis number, a vehicle type (e.g., passenger car, SUV, etc.), a list of controls (for air conditioning, window, tailgate, sunroof, ignition, etc.), info system information (navigation system, sound system grade, number of speakers, connected external devices, support functions, etc.), vehicle apps installed for respective vehicle (videos, streaming app info, a list of contents, playlists, etc.) of a vehicle.

Available services provided based on the group member system database (DB) are classified and displayed. Control authority is given to the group organizer and may be transferred.

The group member service database (DB) is updated in real-time as changes occur in real-time.

The user's cell phone number is used to send group-related messages to the vehicle app. Group request may be made via a vehicle or a personal communication device. If the request is sent via the communication device, it will be delivered as a text or app notification via the vehicle app (Blue Link, KiaConnect, Genesis Concierge), and if a recipient responds to the request, the recipient will become a group member.

For the rear seat monitors, it is advantageous to select the largest monitor as a video sharing monitor since the monitors will be shared with the group members. The monitor in the front seat is not suitable for sharing, even if it is large. Roof monitors or seatback monitors in the rear seats are suitable for sharing.

The group member service database (DB) is related to information stored in a vehicle of an organizer who organized an original group service. The group member service database (DB) is also created on the management server 130. When the actual service is performed, this information is then updated again with respect to vehicles that actually exist at locations where the service is performed. That is, the group member service database (DB) is updated with an on-site group member service (DB-R).

The number expressed in parentheses in the end-of-life (EOL) value indicates the service grade, and the higher the number, the higher the priority. Also, the values in parentheses for the video service and the streaming service indicate the number of services provided.

Further, the steps of the method or algorithm described in connection with the embodiments disclosed herein may be implemented in the form of program instructions that may be executed by various computer means, such as microprocessors, processors, central processing units (CPUs), or the like, and recorded on a computer-readable medium. The computer-readable medium may include, solely or in combination, program (instruction) codes, data files, data structures, and the like.

What is claimed is:

1. A method of providing a group member service to multiple vehicles, the method comprising:
generating, by a plurality of vehicles, vehicle member information about vehicle members of a particular group in response to manipulation by drivers of the plurality of vehicles; and
collecting, by a management server, the vehicle member information, and determining and providing specific services to the vehicle members.

2. The method of claim 1, wherein providing the vehicle member information comprises:
collecting, by an information collection part, the vehicle member information to generate a group member service database; and
determining, by a service setting part, available services based on the group member service database.

3. The method of claim 2, wherein providing the vehicle member information comprises: assigning, by a group setting part, a time-limited schedule to enable group services between the vehicle members during the assigned time-limited schedule interval.

4. The method of claim 2, wherein generating the group member service database comprises:
determining whether the plurality of vehicles is within a specific communication distance; and
updating the group member service database to a new group member service database for on-site vehicles within the specific communication distance according to the determination results.

5. The method of claim 4, wherein the determination results are obtained by using at least one of a location and an estimated arrival time of a shared vehicle among the plurality of vehicles.

6. The method of claim 1, wherein generating the vehicle member information comprises:
sending, by at least one client of the plurality of the vehicles, an acceptance response to a group participation request from the management server; and
based on the acceptance response, performing a vehicle information sharing operation to allow the client to share the vehicle member information with a master of the plurality of vehicles.

7. The method of claim 6, wherein the master is either a group master of the particular group, or a service-specific master of the particular group determined for each of the group services.

8. The method of claim 7, wherein the group master is a vehicle of a particular group's organizer in the plurality of vehicles, and the at least one client is the remaining vehicles among the plurality of vehicles.

9. The method of claim 8, wherein sharing the vehicle member information comprises:
checking, when specific services are selected by the group master, whether respective service-specific masters for the specific services are preset to be allowed;
in response to determining that the service-specific masters are allowed, determining the respective service-specific masters; and
in response to determining that the respective service-specific masters are not allowed, performing a group master management mode in which the group master randomly selects respective service-specific masters for specific services.

10. The method of claim 9, wherein the authority of the respective service-specific masters is transferable from respective vehicles acting as the service-specific master to vehicles acting as the client.

11. The method of claim 10, wherein the authority of a destination route sharing service in which a destination is set in advance, a playlist sharing service in which a playlist currently playing in the master is shared, or a vehicle control service in which control is only allowed during vehicle stopping, which are not affected by vehicle equipment options, among the specific services, is not transferred.

12. The method of claim 10, wherein an authority of any one of a party mode-support service, a video mode-support service, and a music listening-support service, among the specific services, is transferred to a vehicle having a highest score obtained by scoring the vehicles for a presence of specific components.

13. The method of claim 2, wherein the vehicle member information comprises chassis numbers, roles, modem numbers, wireless communication device information, end of life (EOL) information, video services, and streaming services of the vehicle members.

14. The method of claim 1, wherein the management server is configured to communicate with communication means provided in the plurality of vehicles or an application on a communication terminal provided by the drivers of the plurality of vehicles.
